(19) United States
(12) Patent Application Publication
(10) Pub. No.: US 2013/0207324 A1
(43) Pub. Date: Aug. 15, 2013

(54) METHOD FOR MANUFACTURING SILICON CARBIDE SINTERED MATERIAL USING BALL

(71) Applicants: Young Nam Kim, Seoul (KR); Myeong Jeong Kim, Seoul (KR); Min Sung Kim, Seoul (KR)

(72) Inventors: Young Nam Kim, Seoul (KR); Myeong Jeong Kim, Seoul (KR); Min Sung Kim, Seoul (KR)

(73) Assignee: LG INNOTEK CO., LTD., Seoul (KR)

(21) Appl. No.: 13/813,320

(22) PCT Filed: Jul. 28, 2011
(86) PCT No.: PCT/KR2011/005576

§ 371 Date: Apr. 12, 2013

(30) Foreign Application Priority Data
Jul. 30, 2010 (KR) 10-2010-0074353

(51) Int. Cl. C01B 31/36

(52) U.S. Cl. CPC C01B 31/36
USPC 264/669; 264/682

(57) ABSTRACT

A method for manufacturing a silicon carbide (SiC) sintered material according to the embodiment includes the steps of forming a mixture by mixing SiC powder with a resin and a ball; drying the mixture; and loading the dried mixture in a mold to sinter the dried mixture. The ball includes at least one of a Teflon ball, an SiC ball, a silicon nitride ball, an alumina ball, and a zirconia ball.

### TECHNICAL FIELD

The disclosure relates to a method for manufacturing a silicon carbide sintered material. More particularly, the disclosure relates to a method for manufacturing a silicon carbide sintered material using a ball, capable of manufacturing the silicon carbide sintered material having high purity and high density without using sintering aids by selecting a desired type and a desired diameter of the ball during a mixing process.

### BACKGROUND ART

In general, silicon carbide (SiC) and boron (B) are reinforced materials having high tensional ratio. If Al2O3 is representative oxide ceramics, SiC is extensively used as representative non-oxide ceramics. Recently, SiC fiber is widely used in various fields as a reinforced material of ceramic and a metal composite material and a boron fiber is mainly used as an epoxy reinforced material having the high efficiency.

Since pressureless sintering of SiC by adding boron and carbon has been succeed for the first time by Prochazka of G.E. (U.S.A.) in the 1970's, the SiC has been spotlighted as a high-temperature structural material because the SiC represents superior high-temperature strength, wear-resistance, oxidation-resistance, corrosion-resistance and creep-resistance characteristics. The SiC is a high-quality ceramic material, which has been extensively used for mechanical seals, bearings, various nozzles, high-temperature cutting tools, SiC plates, abrasive agents, reducing agents for steel making, and lightning arresters.

Recently, quartz components have been mainly used as materials for electronic information appliances and semiconductors. However, the use of the SiC is inevitable because the processing temperature for a wafer is increased, a water diameter is enlarged, and a processing unit is increased. The electronic information appliances and semiconductors must have the superior heat-resistance property, so the SiC having high density and high purity is necessary.

As a method for manufacturing a sintered material of the SiC, which is rarely sintered, a hot press scheme, a reaction sintering scheme and a pressureless sintering scheme are generally known in the art.

Among them, according to the hot press scheme to manufacture the SiC having high purity using a hot press, SiC powder is mixed with resin serving as a sintering aid and then the mixture is dried. After that, the dried mixture is sintered by applying the temperature of 2000 to 2500° C. and pressure of 20 to 40 Mpa to the dried mixture using the hot press.

Meanwhile, according to the method for manufacturing the SiC sintered material using the ball of the related art, SiC powder is mixed with resin and solvent (organic solvent, such as alcohol, methanol or IPA) by a ball mill or a planetary mill.

When the mixing process is performed, various types of balls can be utilized.

After that, the solvent is volatilized such that the mixture is converted into powder, and the powder is loaded in a graphite mold for the hot press sintering. Then, the sintering process is performed under predetermined pressure, thereby manufacturing the sintered material.

However, according to the method for manufacturing the SiC sintered material of the related art, there is no efficient limitation to select the type of the ball in the mixing step. As a result, friction occurs between the ball and the SiC powder, so that impurities of the ball may be erupted.

### DISCLOSURE OF INVENTION

### Technical Problem

The embodiment provides a method for manufacturing an SiC sintered material, capable of determining the type of a ball for efficient mixing such that impurities of the ball are not erupted.

### Solution To Problem

A method for manufacturing a silicon carbide (SiC) sintered material includes the steps of forming a mixture by mixing SiC powder with a resin and a ball; drying the mixture; and loading the dried mixture in a mold to sinter the dried mixture, wherein the ball includes at least one of a Teflon ball, an SiC ball, a silicon nitride ball, an alumina ball, and a zirconia ball.

The ball exclusively includes the alumina ball or the zirconia ball.

The ball exclusively includes the silicon nitride (Si3N4) ball.

The mixture is obtained by using a jar.

The mixture is dried by using a spray dryer.

The dried mixture is sintered by loading a mold in a hot press and applying heat and pressure to the mold.

### Advantageous Effects of Invention

According to the method for manufacturing the SiC sintered material of the embodiment, a ball capable of minimizing impurities of the ball can be selected during the ball mill mixing, so that the SiC sintered material having high purity and high density can be manufactured.

In particular, the ball mill mixing is performed by using a silicon nitride ball, so the SiC sintered material having high purity and high density with impurities of 5 ppm or less can be manufactured.

In other words, according to the method for manufacturing the SiC sintered material of the embodiment, impurities generated due to friction between the SiC and the ball can be minimized during the ball mill mixing process, so that the SiC sintered material having high purity and high density can be manufactured.

### BRIEF DESCRIPTION OF DRAWINGS

FIG. 1 is a flowchart showing a method for manufacturing an SiC sintered material according to the first embodiment; and

FIG. 2 is a perspective view showing a ball mill mixing process in a method for manufacturing an SiC sintered material according to the first embodiment. Mode for the Invention

Hereinafter, a method for manufacturing a silicon carbide (SiC) sintered material according to the embodiment will be described in detail with reference to the accompanying drawings.

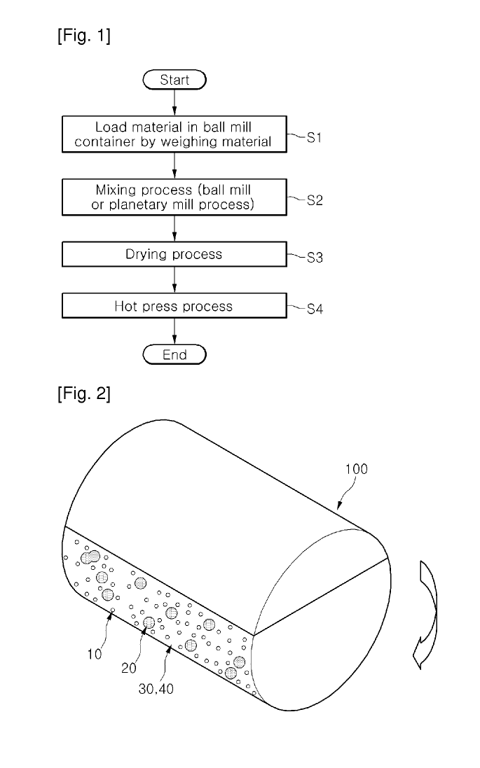

FIG. 1 is a flowchart showing a method for manufacturing an SiC sintered material according to the first embodiment.

Referring to FIG. 1, the method for method for manufacturing a silicon carbide (SiC) sintered material includes the steps of forming a mixture by mixing SiC powder with resin and a ball (S1 and S2), drying the mixture (S3), and loading the dried mixture in a mold to sinter the dried mixture (S4). The ball includes at least one of a Teflon ball, an SiC ball, a silicon nitride ball, an alumina ball, and a zirconia ball.

Hereinafter, the above steps will be described in more detail.

In the step of forming the mixture by mixing SiC powder with resin and the ball (S1 and S2), the SiC powder and the resin are input into a mixing container after weighing the SiC powder and the resin, and the ball is input into the mixing container to mix the ball with the SiC powder and the resin by using a planetary bill. The SiC powder for manufacturing the SiC sintered material can be formed depending on the mixture.

At this time, the ball may include at least one of a Teflon ball, an SiC ball, a silicon nitride ball, an alumina ball, and a zirconia ball.

FIG. 2 is a perspective view showing the mixing process performed by a ball mill.

Referring to FIG. 2, at least one 20 of the Teflon ball, the SiC ball, the silicon nitride ball, the alumina ball and the zirconia ball is input into a container 130 together with SiC powder 10 and then an organic solvent 40 and a resin 30 are input into the container 130. After that, the container 130 is rotated to mix the materials in the container 130.

During the ball mill process, impurities of the ball may be erupted into the mixture according to the type of the balls, so the selection of the ball is very important.

In the step of drying the mixture (S3), the mixture obtained through the mixing process is dried.

At this time, a spray dryer may be used to remove the solvent by drying the mixture.

In the step of sintering the dried mixture (S4), the dried mixture, that is, the powdered material is loaded in a mold and the sintering process is performed under the predetermined pressure, thereby manufacturing the SiC sintered material.

Hereinafter, the method for manufacturing the SiC sintered material according to the embodiments will be described in more detail. However, the embodiments are illustrative purposes only and the disclosure is not limited to the embodiments.

### EMBODIMENT 1

After weighing 576 g of SiC and 24 g of resin, the SiC and the resin are input into a Teflon container. Then, a Teflon ball is input into the Teflon container and mixed with the SiC and the resin for 10 hours by a planetary mill. After that, the mixture is dried by a spray dryer so that powder is prepared. Then, the powder is loaded in a graphite mold and the graphite mold is loaded in a hot press. In this state, the temperature of the hot press rises up to 600° C. at the rate of 10° C./min under the vacuum atmosphere and the graphite mold is kept in the hot press for one hour while supplying argon gas into the hot press. After that, the temperature of the hot press sequentially rises up to 2000° C. at the rate of 5° C./min and up to 2250° C. at the rate of 3° C./min. In this state, the graphite mold is kept in the hot press for three hours. Then, the sintering process is performed while pressing the graphite mold at the pressure of 40 Mpa, thereby manufacturing the SiC sintered material.

### EMBODIMENT 2

Embodiment 2 is the same as Embodiment 1 except that the SiC ball is employed instead of the Teflon ball.

### EMBODIMENT 3

Embodiment 3 is the same as Embodiment 1 except that the silicon nitride ball is employed instead of the Teflon ball.

### EMBODIMENT 4

Embodiment 4 is the same as Embodiment 1 except that the alumina ball is employed instead of the Teflon ball.

### EMBODIMENT 5

Embodiment 5 is the same as Embodiment 1 except that the zirconia ball is employed instead of the Teflon ball.

The density and the content of impurity of the SiC sintered material manufactured through Embodiments 1 to 5 are shown in Table 1.

TABLE 1

| | Teflon | | Silicon nitride | Alumina | |
|---|---|---|---|---|---|
| | ball | SiC ball | ball | ball | Zirconia ball |
| Density | 2.75 | 3.0 | 3.17 | 3.17 | 3.17 |
| (g/cm³) | | | | | |
| Impurity | 5 or less | 5 or less | 5 or less | 1015 | 873 |
| content | | | | | |
| (ppm) | | | | | |

Referring to Table 1, when the alumina ball and the zirconia ball are used, the content of impurity is 1015 ppm and 873 ppm, respectively. In addition, when the Teflon ball, the SiC ball and the silicon nitride ball are used, the content of impurity is 5 ppm or less, respectively. The impurity includes Na, Al, K, Ca, Ti, Cr, Fe, Ni and Cu.

In addition, when the Teflon ball and the SiC ball are used, the density of the SiC sintered material is 3.0 g/cm³ or less. However, when the silicon nitride ball, the alumina ball and the zirconia ball are used, the density of the SiC sintered material is more than 3.0 g/cm³, for instance, 3.17 g/cm³.

For example, when the silicon nitride ball are used, the density of the SiC sintered material is between 3.0 g/cm³ and 3.21 g/cm³ or between 3.0 g/cm³ and 3.17 g/cm³

In other words, when the Teflon ball, the SiC ball or the silicon nitride ball is used, the SiC sintered material having the high purity can be manufactured. In addition, when the silicon nitride ball, the alumina ball or the zirconia ball is used, the SiC sintered material having the high density can be manufactured.

In particular, when the silicon nitride ball is used, the SiC sintered material represents the high density of 3.17 g/cm³ and the high purity having the impurity content of 5 or less.

Therefore, the SiC sintered material having the high density or the high purity can be manufactured by selecting the type of the balls according to applications. For instance, if the SiC sintered material having the high density is necessary, the alumina ball or the zirconia ball representing the density of 3.17 g/cm³ is selected. In addition, when the SiC sintered material having the high density and the high purity used for the semiconductor process is necessary, the silicon nitride ball representing the density of 3.17 g/cm³ is selected. The above balls can be used together if necessary.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method for manufacturing a silicon carbide (SiC) sintered material, the method comprising:
forming a mixture by mixing SiC powder with a resin and a ball;
drying the mixture; and
loading the dried mixture in a mold to sinter the dried mixture,
wherein the ball includes at least one of a Teflon ball, a silicon carbide ball, a silicon nitride ball, an alumina ball, and a zirconia ball.

2. The method of claim 1, wherein the ball is the alumina ball or the zirconia ball.

3. The method of claim 1, wherein the mixture is obtained by using a jar.

4. The method of claim 1, wherein the mixture is dried by using a spray dryer.

5. The method of claim 1, wherein the dried mixture is sintered by loading a mold in a hot press and applying heat and pressure to the mold.

6. A method for manufacturing a silicon carbide (SiC) sintered material, the method comprising:
forming a mixture by mixing SiC powder with a resin and a ball;
drying the mixture; and
loading the dried mixture in a mold to sinter the dried mixture,
wherein the ball includes a silicon nitride ball.

7. The method of claim 6, wherein the SiC sintered material includes impurity in a range of 0.01 ppm to 5 ppm.

8. The method of claim 6, wherein the SiC sintered material has density in a range of 3.0 g/cm³ to 3.21 g/cm³.

9. The method of claim 6, wherein the mixture is obtained by using a jar.

10. The method of claim 6, wherein the mixture is dried by using a spray dryer.

11. The method of claim 6, wherein the dried mixture is sintered by loading a mold in a hot press and applying heat and pressure to the mold.
